(19) United States
(12) Patent Application Publication
(10) Pub. No.: US 2021/0307114 A1
(43) Pub. Date: Sep. 30, 2021

(54) Heating Device

(71) Applicant: Mikhail Leonidovich Strupinskij, Moscow (RU)

(72) Inventor: Mikhail Leonidovich Strupinskij, Moscow (RU)

(21) Appl. No.: 17/201,664

(22) Filed: Mar. 15, 2021

(30) Foreign Application Priority Data
Mar. 26, 2020 (RU) 2020112432

(51) Int. Cl. H05B 1/02; H05B 3/12; H05B 3/18; H05B 3/40

(52) U.S. Cl. CPC H05B 1/0291; H05B 3/12; H05B 2203/019; H05B 3/40; H05B 3/18

(57) ABSTRACT

Heating devices based on self-regulating heating tape for various industries. Heating device comprises a self-regulating heating tape and external metal flexible armor, wherein a metal strip has a longitudinal groove, and the edge of the strip has a flange. The heating tape comprises two conductors which are insulated from each other and placed into a conducting polymer matrix enclosed in a polymer insulating sheath. The heating device has high mechanical strength, high flexibility, tightness, high resistance to external aggressive media, and fire safety.

### RELATED APPLICATIONS

This application claims priority to Russian Patent Application No. RU 2020112432, filed Mar. 26, 2020, which is incorporated herein by reference in its entirety.

### FIELD OF THE INVENTION

The disclosure pertains to heating devices based on self-regulating heating tape and can be used in various industries.

### BACKGROUND

Heating devices comprising self-regulating tapes are widely known in the art.

A self-regulating tape is a conductive carbon (polymer) matrix (base) with conductive cores in it and conductive particles dispersedly distributed between them.

The matrix is characterized by a considerable dependence of the conductivity on the temperature, and the negative temperature resistance coefficient of the conducting plastics is by an order of magnitude higher than that of copper or steel. This ensures self-regulation of heating power of the heating cable. The self-regulating heating tape can change its power locally, only in the overheated zone.

During the heating, as the polymer base expands, the distance between the conductive particles incorporated in the base becomes greater resulting in the decreasing amount of current conducting connections (paths) in the matrix between current conducting particles, which increases the matrix resistance, reduces its electric conductivity, moreover local heating of an overheated tape section becomes decreased. After the tape section cools down, the polymer base takes the dimensions close to the original ones, and heating continues.

The low temperature self-regulating tape may ensure the device heating from +10° C. to +50° C., moreover, due to its thermal characteristics, the heating tape allows automatically reducing the power consumption at the temperature of +50° C. by more than 50%.

A self-regulating heating tape is known in the prior art, which consists of two current conducting cores insulated from each other arranged in a current conducting polymer matrix incorporated in a polymer insulating sheath (see CN 109379793 A, 22 Feb. 2019).

The disadvantages of the known solution are low structural strength of the heating tape, insufficient protection from the external aggressive media and fire safety considerations.

### BRIEF SUMMARY

Disclosed is a heating device based on a self-regulating heating tape with high operating performance.

The heating device has high mechanical strength, high flexibility, tightness, high resistance to external aggressive media (including ultraviolet), and fire safety.

The result is achieved by using an aggregate of the features: the heating device comprises a self-regulating heating tape incorporating two current conductive cores insulated from each other arranged in a current conductive polymer matrix enclosed in a polymer insulating sheath; the device may contain an external flexible metal armoring.

In some embodiments, the armoring may be made of a metal strip by winding with the overlapping pitch of 0.5 maximum.

In some embodiments, the armoring strip may have a longitudinal groove and the strip edge is flanged for installation into the groove during winding.

In some embodiments, the tape may additionally contain a copper, a tin, or a copper-tin braiding.

In some embodiments, the tape may additionally comprise a polyolefin or a fluoroplastic sheath.

In some embodiments, a solid water-blocking layer may be applied or an additional water-blocking insulating winding of the device may be provided directly under the external metal armoring.

In some embodiments, a hydrophobe may be used as a water blocking layer or winding.

In some embodiments, a water-blocking layer may be applied or an additional water-blocking insulating winding of the device may be provided directly on the polymer insulating sheath.

In some embodiments, a hydrophobe is used as a water blocking layer or winding.

### BRIEF DESCRIPTION OF THE SEVERAL VIEWS OF THE DRAWINGS

FIG. 1 shows a general view of an example heating device.

FIG. 2 shows an example heating device with an external conductive braiding.

### DETAILED DESCRIPTION

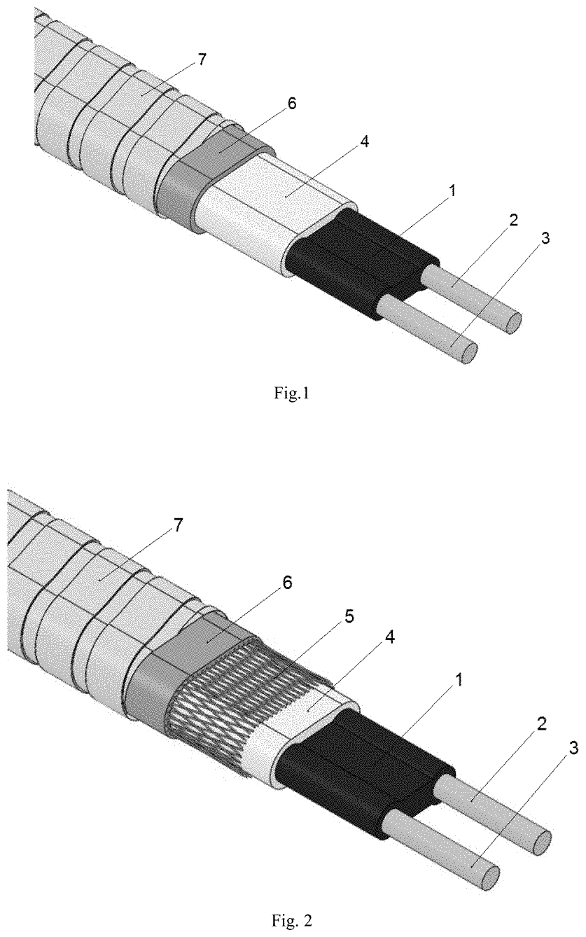

FIG. 1 represents a heating device based on a parallel resistive self-regulating tape. The tape consists of the conductive polymer matrix 1 pressed by extrusion around the two parallel current conducting cores 2 and 3. The matrix serves as a heating element. The polymer insulating sheath 4 of polyolefin or fluoroplastic is pressed onto the matrix 1 by extrusion. Usually, for the additional mechanical protection and/or the use as a grounding wire, the conducting braiding 5 is added (for example, a tin or copper-tin or copper braiding). Such a braiding is usually covered by a thermoplastic external winding 6 for the additional mechanical and corrosion protection.

Parallel resistive self-regulating tapes have a number of advantages compared to non-self-regulating heating tapes and, therefore, are more popular. For example, self-regulating heating tapes are not subjected to overheating due to their temperature characteristics. As the temperature at any location of the tape grows, the heating element's resistance at this point becomes higher and reduces the output power at this point; thus, the heater effectively switches off.

The heating device contains an external flexible metal armoring 7 made of metal strip winding. The winding is made by the overlapping winding pitch of no more than 0.5. With the pitch above 0.5, the device flexibility would be lower, which will make its usage and installation more difficult. Depending on the necessary strength or flexibility of the device, the pitch may vary between 0.1 and 0.5. As the flexibility grows, the pitch will be closer to 0.1; as the strength grows, the pitch will be closer to 0.5. The availability of the external armoring increases the mechanical strength of the heating device in general with preserving the relatively higher flexibility.

The metal strip has a longitudinal groove, and the strip edge is flanged for installation to the groove during winding of the next tape wind on the device. Depending on the winding pitch, the longitudinal groove location is selected. For the winding pitch of 0.5 the longitudinal groove is made in the center of the tape; the longitudinal groove is shifted to the edge of the tape as the pitch decreases to 0.1.

The availability of the groove in the tape, close contact of the bound tape to this groove during its winding, reliable fixing of the flange in the groove allows obtaining a non-permeable external armoring of the device as well as considerably increasing the seal tightness of the heating device.

Seal tightness of the heating device and the availability of the external metal sheath allows increasing the device resistance to aggressive external media, including ultraviolet radiation, and improving its fire safety.

A continuous solid water-blocking layer may be applied or an additional water-blocking insulating winding of the device (not shown in the drawings) may be provided directly under the external metal armoring 7 for additional improvement of sealing properties and waterproofing of the heating tape. A hydrophobe may be used as a water blocking layer or winding. A water-blocking layer or an additional water-blocking winding may also additionally be applied and provided directly on the polymer insulating sheath.

In addition, an advantage of the heating device is that it can be cut to the required length on site without additional structural complexities.

An example embodiment of the heating device.

A semiconducting self-regulating matrix is pressed around two parallel tin-plated copper cores of 1.25 mm² in cross-section. An insulating sheath of thermoplastic elastomer (polyolefin) covered with a meshed braiding of tin-plated copper wire is pressed onto the matrix. The tin braiding is covered with a thermoplastic winding.

The heating tape is placed into a steel sheath applied by winding a steel tape around the heating tape. The winding pitch is 0.5. The power supply of the heating device is 220-240V. The maximum temperature of the device is 65° C.

The heating device is approved for the use in both the safe and explosion hazard environments under GOST R IEC 60079-0-2011, GOST R IEC 60079-7-2012, GOST IEC 60079-30-1-2011. The ingress protection of the device under GOST 14254-96 is IP67.

1. A heating device comprising:
a self-regulating heating tape comprising:
a conductive polymer matrix within a polymer insulating sheath; and
two conductive cores insulated from each other and arranged within the matrix; and
an external flexible metal armoring comprising a metal strip wound around the device,
wherein the wound strip comprises:
a longitudinal groove, and
a flange along an edge of the strip fitting into the groove.

2. The heating device according to claim 1,
wherein the tape further comprises a copper, tin, or tin-copper braiding.

3. The heating device according to claim 1,
wherein the tape further comprises a polyolefin or fluoroplastic sheath.

4. The heating device according to claim 1,
further comprising under the external metal armoring a continuous water-blocking layer or a water-blocking insulating winding.

5. The heating device according to claim 4,
wherein the water-blocking layer or winding comprises hydrophobe.

6. The heating device according to claim 1,
further comprising over the external metal armoring a continuous water-blocking layer or a water-blocking insulating winding.

7. The heating device according to claim 6,
wherein the water-blocking layer or winding comprises hydrophobe.
